(19) United States
(12) Patent Application Publication
(10) Pub. No.: US 2026/0192590 A1
(43) Pub. Date: Jul. 9, 2026

(54) Filing Placeholder Device

(71) Applicant: Charlotte Scott, Greene, NY (US)

(72) Inventor: Charlotte Scott, Greene, NY (US)

(21) Appl. No.: 19/308,467

(22) Filed: Aug. 25, 2025

Related U.S. Application Data
(60) Provisional application No. 63/742,281, filed on Jan. 6, 2025.

(51) Int. Cl. B42F 23/00

(52) U.S. Cl. CPC B42F 23/00

(57) ABSTRACT

A placeholder device for marking the position of a removed item, such as a file or folder, within an organized storage system (i.e., filing cabinet/drawer) is disclosed. The device includes an elongated body configured for vertical insertion into the space vacated by the removed item and a head portion positioned at one end of the body to remain visible above adjacent items. The device further includes an attachment mechanism, such as a magnetic strip, enabling the device to be stored on an exterior surface of the storage system when not in use. The head portion includes a receiving surface for removably attachable overlay identification members bearing visual indicia, such as color patterns or writable surfaces, for aiding in item identification and organization. The device provides a simple, reusable solution for tracking the temporary removal and accurate reinsertion of stored items (i.e., files or folders).

### CROSS REFERENCE TO RELATED APPLICATION

The present application claims priority to, and the benefit of, U.S. Provisional Application No. 63/742,281 which was filed on Jan. 6, 2025, and is incorporated herein by reference in its entirety.

### FIELD OF THE INVENTION

The present invention generally relates to document management tools. More specifically, the invention relates to a portable filing placeholder device configured to mark the location of a removed file within a filing cabinet in an efficient, reusable, and highly visible manner. The invention comprises an elongated, semi-rigid shaft with a wide head portion, designed for vertical insertion between file folders when a folder is temporarily removed. A magnetic strip on the rear surface enables the device to be stored on the exterior of the filing cabinet when not in use. The head portion includes a receiving surface for attachable identification overlays that can be color-coded, patterned, or labeled to support quick file identification and organization. The invention provides a low-cost, user-friendly solution for preventing misfiling and maintaining order in paper-based filing systems and is compatible with a wide range of standard vertical and lateral filing cabinets used in offices, archives, medical practices, and other recordkeeping environments. Accordingly, the present disclosure makes specific reference thereto. Nonetheless, it is to be appreciated that aspects of the present invention are also equally applicable to other like applications, devices, and methods of manufacture.

### BACKGROUND

By way of background, many business environments continue to rely on physical documentation. In such businesses, filing systems are comprised of paper folders stored within filing cabinets. The systems commonly organize folders alphabetically, numerically, or by subject matter to facilitate retrieval. However, even in well-organized systems, locating a specific file can be time-consuming due to the volume of documents and the similarity of folder appearances. Especially, once a file has been removed for use, accurately returning it to its original position within the filing cabinet presents a significant challenge. Users often misplace or misfile folders, leading to disorganization, wasted time, and even lost or inaccessible records. Misplacing a folder can negatively impact workflow efficiency, recordkeeping accuracy, and compliance in regulated industries. Individuals desire a simple, reusable, and effective solution that helps users track the removal and proper reinsertion of folders in filing systems, reducing the risk of misfiling.

Therefore, there exists a long-felt need in the art for a filing management tool that enables the accurate return of documents to their original position within filing cabinets. There is a long-felt need for a simple, intuitive solution that reduces the risk of misfiling, disorganization, and time loss associated with traditional paper-based filing systems. Additionally, there is a long-felt need for a portable, reusable, and clearly visible marker that can be quickly deployed at the point where a folder is removed and just as easily retrieved when the file is returned. Furthermore, there is a long-felt need for a filing aid that is compatible with existing filing cabinet infrastructures, does not require permanent installation, and can be stored conveniently when not in use. More specifically, there is a long-felt need for a filing placeholder device that can be used in high-turnover or shared file environments such as offices, libraries, archives, and healthcare facilities. Finally, there is a long-felt need in the art for a device that saves considerable time and effort when retrieving and replacing files in a filing cabinet.

The subject matter disclosed and claimed herein, in one embodiment, comprises a filing placeholder device configured to be inserted into a filing drawer at the precise location from which a file or folder is removed. The device includes an elongated planar shaft formed of a semi-rigid material and dimensioned for compatibility with standard filing drawer systems. A wide head portion is disposed at the top end of the shaft, the head extending above adjacent folders when the device is inserted. A magnetic strip is affixed to the rear surface of the shaft, enabling the device to be stored on a side surface of the filing cabinet when not in use. The head portion may further include a semi-circular receiving surface configured to accept removably attachable overlay markers or identification members bearing visual patterns, colors, or writable surfaces to assist in folder tracking and organization.

In another embodiment, the placeholder device includes a plurality of interchangeable identification overlays, each conforming to the shape of the head portion and attachable using adhesive, friction-fit, or magnetic means. These overlays may feature printed indicia, dry-erase surfaces, or color-coded patterns to support categorization or workflow labeling.

In this manner, the filing placeholder device of the present invention fulfills the long-felt need for a practical, reusable, and efficient solution to a persistent problem in manual file management. The device enables individuals to confidently remove and return files without the risk of misplacement and improves the accuracy and speed of paper-based workflows. The device prevents individuals from accidentally placing a file back in the cabinet in the wrong place and saves considerable time and effort when retrieving and replacing files.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a filing placeholder device for marking the location of a removed file within a filing cabinet. The device comprises an elongated planar shaft extending linearly between a bottom end and a top end, the shaft has a length not exceeding a height of a standard filing cabinet drawer, the shaft being formed of a semi-rigid material, a magnetic strip is affixed to or embedded in a posterior surface of the shaft and extends along a central longitudinal axis thereof, the magnetic strip is configured to magnetically adhere to a ferromagnetic surface of the filing cabinet, a head member is integrally formed at the top end of the shaft, the head member having a semi-circular receiving surface configured to protrude above file folders when the shaft is inserted into the filing cabinet, a plurality of overlay identification members, each comprising a semi-circular insert is shaped to conform to the receiving surface, wherein the identification members are removably attachable to the head member.

In another aspect, the elongated planar shaft extends linearly between a bottom end and a top end, the shaft has a width in the range of approximately 1.5 inches to 2 inches and a thickness of approximately 0.125 inches.

In another embodiment, a method of marking and restoring the location of a removed file in a filing cabinet using a filing placeholder device is described. The method includes the steps of retrieving a filing placeholder device magnetically adhered to a side surface of a filing cabinet, the device comprises an elongated planar shaft with a magnetic strip and a head member with a semi-circular identification marker, inserting the filing placeholder device vertically into a filing drawer at a location from which a file folder has been removed, such that the head member protrudes above the adjacent file folders to act as a visible marker after the file folder is no longer in use, reinserting the file folder into the same location in the drawer indicated by the placeholder device, and removing the placeholder device from the drawer and reattaching it to the side surface of the filing cabinet using the magnetic strip.

In one embodiment, a placeholder device for indicating the location of a removed item within an organized storage system is disclosed. The device comprises an elongated body configured for insertion into a gap formed by removal of an item from the storage system, a head portion is disposed at one end of the elongated body, the head portion is configured to remain visible above adjacent items when the body is inserted, wherein the placeholder device includes a magnetic strip for attachment to an external surface of the storage system when not in use.

In yet another aspect, the head portion includes a receiving surface configured to selectively receive a removably attachable overlay identification member having a visible pattern selected from the group consisting of a multicolored design, symbolic indicia, or a dry-erase writable surface.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a rear perspective view of one potential embodiment of filing placeholder device of the present invention in accordance with the disclosed structure;

FIG. 2 illustrates a perspective view showing how the functional overlay identification member is attached to the semi-circular placeholder in accordance with the disclosed structure;

FIG. 3 illustrates a perspective view showing the filing placeholder device adhered to the side of a filing cabinet, as a folder is being removed in accordance with the disclosed structure;

FIG. 4 illustrates a perspective view showing the placeholder device placed in the filing cabinet to function as a placeholder marker in accordance with the disclosed structure; and

FIG. 5 illustrates a perspective view showing the functional workflow of removing the filing placeholder device when the file for which the device is placed is returned to the cabinet.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a filing management tool that enables the accurate return of documents to their original position within filing cabinets. There is a long-felt need for a simple, intuitive solution that reduces the risk of misfiling, disorganization, and time loss associated with traditional paper-based filing systems. Additionally, there is a long-felt need for a portable, reusable, and clearly visible marker that can be quickly deployed at the point where a folder is removed and just as easily retrieved when the file is returned. Furthermore, there is a long-felt need for a filing aid that is compatible with existing filing cabinet infrastructures, does not require permanent installation, and can be stored conveniently when not in use. More specifically, there is a long-felt need for a filing placeholder device that can be used in high-turnover or shared file environments (i.e., multiple personnel) such as offices, libraries, archives, and healthcare facilities. Finally, there is a long-felt need in the art for a device that saves considerable time and effort when retrieving and replacing files in a filing cabinet.

The present invention, in one exemplary embodiment, is a placeholder device for indicating the location of a removed item within an organized storage system is disclosed. The device comprises an elongated body configured for insertion into a gap formed by removal of an item from the storage system, a head portion is disposed at one end of the elongated body, the head portion is configured to remain visible above adjacent items when the body is inserted, wherein the placeholder device includes a magnetic strip for attachment to an external surface of the storage system when not in use.

Reference will now be made in detail to the present preferred embodiments of the invention, examples of which are illustrated in the accompanying drawings. Wherever possible, the same reference numerals are used in the drawings and the description to refer to the same or like parts.

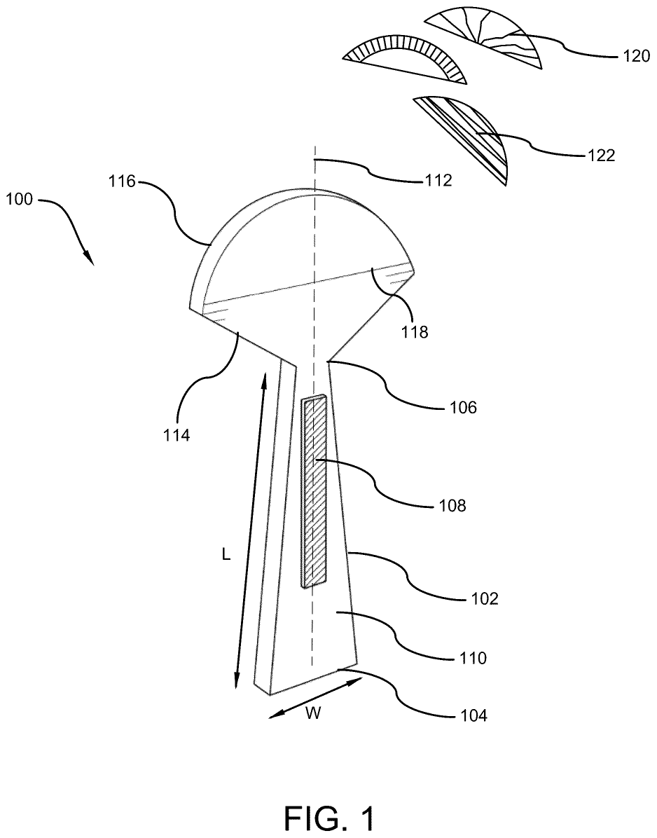

Referring initially to the drawings, FIG. 1 illustrates a rear perspective view of one potential embodiment of filing placeholder device of the present invention in accordance with the disclosed structure. The filing placeholder device 100 of the present invention is designed as a simple and effective tool for tracking the temporary removal of folders or files from a filing cabinet. The filing placeholder device 100 is lightweight, portable, magnetically attachable, and compatible with conventional vertical or lateral filing cabinet systems. More specifically, the filing placeholder device 100 includes an elongated planar shaft 102 extending linearly between a bottom end 104 and a top end 106 thereof. The shaft 102 is preferably formed of a semi-rigid polymeric or composite material and has a width “W” in the range from about 1.5 inches to about 2 inches. The length “L” of the shaft 102 is user-configurable but does not exceed the vertical height of a standard filing cabinet drawer. In one exemplary embodiment, the length of the shaft 102 corresponds to a height of files contained in the filing cabinet. Further, the elongated planar shaft 102 has a thickness from about 0.0625 inches to about 0.2500 inches. The elongated planar shaft 102 can be generally rectangular or tapered (i.e., tapered from a narrow top end to a wide bottom end) to accommodate requirements of different users.

A magnetic strip 108 is affixed to or embedded in the posterior surface 110 of the elongated planar shaft 102. The magnetic strip 108 extends substantially along the central axis 112 of the posterior surface 110 to provide magnetic adherence to ferromagnetic surfaces such as steel filing cabinet side walls. The magnetic strip 108 may be recessed or co-planar with the surface 110 to maintain a uniform rear profile.

A wide head member 114 is integrally formed at the top end 106 of the elongated planar shaft 102. The wide head member 114 has a semi-circular receiving surface or placeholder 116 along the top edge 118 thereof. The receiving surface 116 is dimensioned and contoured to accommodate removably attachable overlay identification members 120.

Each overlay identification member 120 comprises a semi-circular insert shaped to correspond with the receiving surface 116, and includes a visible pattern 122, such as a multicolored graphic, writable dry-erase surface, or symbolic indicia. These overlays may be fabricated from laminated paper, flexible plastic, or polymeric films, and optionally include surface coatings for erasability, durability, or customization.

In operation, the device 100 is inserted vertically into a filing drawer at the location or position from which a folder is removed. The head member 114 and/or receiving surface 116 remains visible above the height of the adjacent file folders, enabling the user to visually identify the folder's original position. The interchangeable overlay 120 further aids identification and organization through coded or thematic labeling.

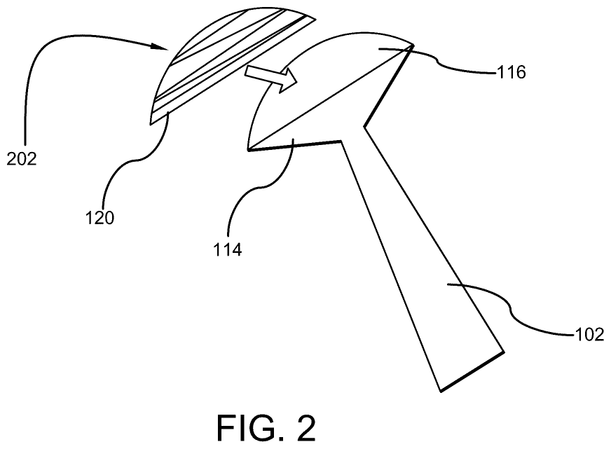

FIG. 2 illustrates a perspective view showing how the functional overlay identification member is attached to the semi-circular placeholder in accordance with the disclosed structure. The overlay identification member 120 has an adhesive bonding 202 along the rear surface thereof and is positioned onto the top of the placeholder 116 as indicated by arrow “A”. The overlay identification member 120 once placed, does not move unintentionally and can be removed and replaced with another identification member.

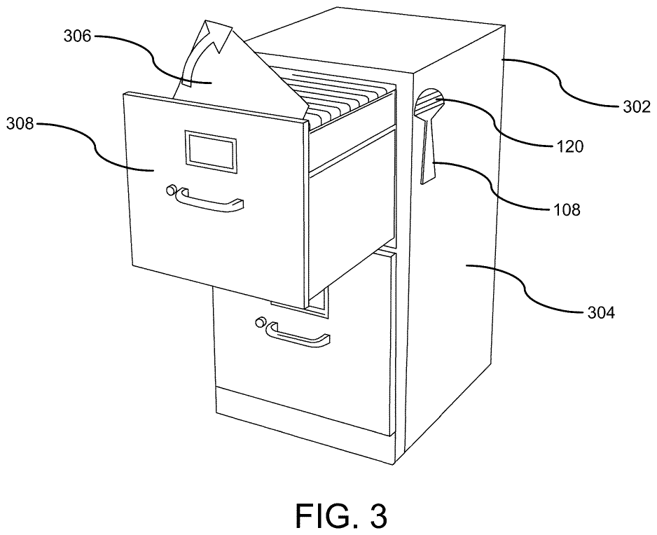

FIG. 3 illustrates a perspective view showing the filing placeholder device adhered to the side of a filing cabinet, as a folder is being removed in accordance with the disclosed structure. The placeholder device 100 includes the magnetic strip 108 affixed to its posterior surface, enabling magnetic attachment to ferromagnetic surfaces such as the cabinet's side wall as described in FIG. 1. Specifically, the placeholder device 100 is magnetically attachable to a filing cabinet 302 such as on a side surface 304 of the filing cabinet 302 for easy storage and accessibility using the built-in magnet strip 108. Upon removal of a folder 306 from the filing cabinet 302 (drawer 308), a user may retrieve the placeholder device 100 from the side surface 304 and insert the placeholder device 100 vertically into the filing drawer at the location or position from which the folder was removed.

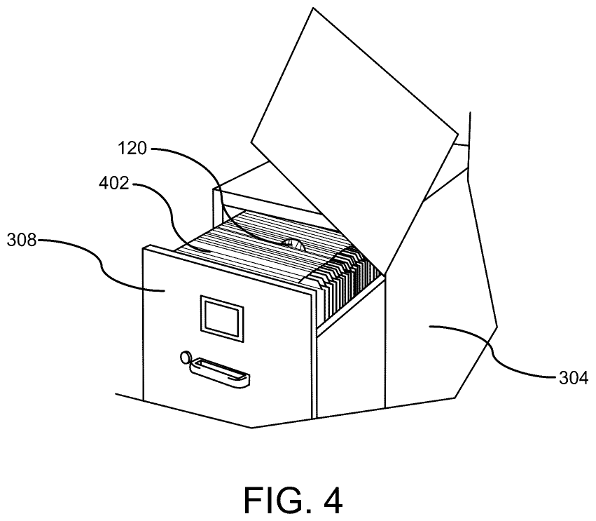

FIG. 4 illustrates a perspective view showing the placeholder device placed in the filing cabinet to function as a placeholder marker in accordance with the disclosed structure. When the placeholder device 100 is inserted into the filing cabinet drawer, the overlay identification member 120 disposed on the receiving surface 116 protrudes above the file folders 402. The placeholder device 100 acts as a temporary marker to remember the file's original position and the overlay identification member 120 is easily visible for easy identification of the position of the removed file folder.

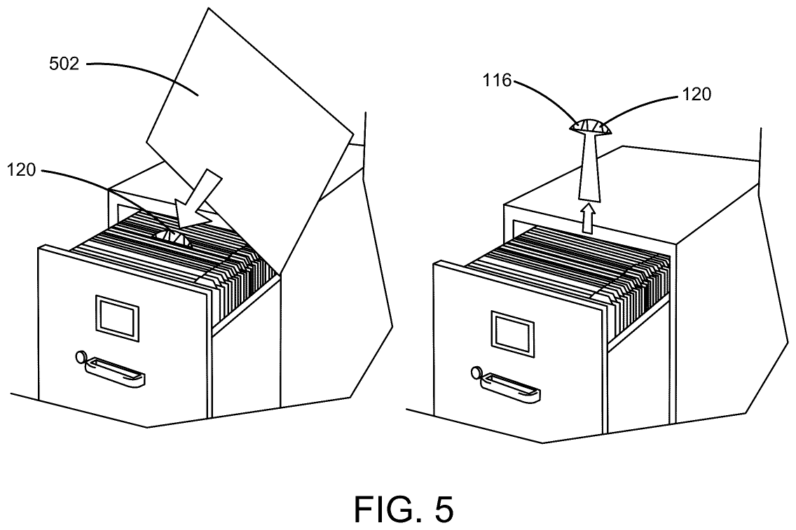

FIG. 5 illustrates a perspective view showing the functional workflow of removing the filing placeholder device when the file for which the device is placed is returned to the cabinet. For returning the removed folder or file 502, a user visually locates the placeholder device 100 within the filing drawer and the semi-circular marker 120, which extends vertically above the top edge of the file folders, provides a highly visible indicator of the removed folder's original position. Then, the removed folder or file 502 is aligned with the gap in the filing system where the placeholder device 100 is currently inserted and the folder or file (i.e., file folder) 502 is inserted into the same slot in the hanging file rail or between adjacent folders, effectively returning the folder or file 502 to its original location. Once the folder or file 502 is securely in place, the user grasps the exposed overlay marker 120 and the head 116 of the placeholder device 100 using a pinching or pulling motion and is lifted vertically upward from the drawer. The removed placeholder device can then be reattached to the side surface of the filing cabinet using the magnetic strip on its posterior face as illustrated in FIG. 3.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “placeholder device, “filing placeholder device”, and “device” are interchangeable and refer to the filing placeholder device 100 of the present invention.

Notwithstanding the foregoing, the filing placeholder device 100 of the present invention can be of any suitable configuration as is known in the art without affecting the overall concept of the invention, provided that it accomplishes the above stated objectives. One of ordinary skill in the art will appreciate that the filing placeholder device 100 as shown in the FIGS. are for illustrative purposes only, and that many other configurations of the filing placeholder device 100 are well within the scope of the present disclosure. Although the dimensions of the filing placeholder device 100 are important design parameters for user convenience, the filing placeholder device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A filing placeholder device comprising:
a filing placeholder having an elongated planar shaft, a magnetic strip, and a wide head member;
wherein said elongated planar shaft extending between a bottom end and a top end;
wherein said elongated planar shaft having a material selected from the group consisting of a semi-rigid polymeric material and a semi-rigid composite material;
wherein said elongated planar shaft having a taper including a wide said bottom end tapering to a narrow said top end;
wherein said magnetic strip is embedded in a posterior surface of said elongated planar shaft;
wherein said wide head member integrally formed at said top end of said elongated planar shaft;
wherein said wide head member having a semi-circular receiving placeholder along a top edge of said wide head member; and
further wherein said semi-circular receiving placeholder selectively receives a removably attachable overlay identification member.

2. The filing placeholder device of claim 1, wherein each of said overlay identification member having a semi-circular insert shaped to correspond with said semi-circular receiving placeholder.

3. The filing placeholder device of claim 2, wherein each of said overlay identification member having a visible pattern selected from the group consisting of a multicolored graphic and a writable dry-erase surface.

4. The filing placeholder device of claim 3, wherein each of said overlay identification member having a material selected from the group consisting of a laminated paper, a flexible plastic, and a polymeric film.

5. The filing placeholder device of claim 4, wherein said magnetic strip extends along a central axis of said posterior surface to provide magnetic adherence to ferromagnetic surfaces.

6. The filing placeholder device of claim 5, wherein said elongated planar shaft having a thickness from 0.0625 inches to 0.2500 inches.

7. The filing placeholder device of claim 6, wherein said magnetic strip is co-planar with an exterior surface of said elongated planar shaft.

8. The filing placeholder device of claim 7, wherein said elongated planar shaft having a width from 1.5 inches to 2 inches.

9. The filing placeholder device of claim 8, wherein a length of said elongated planar shaft corresponds to a height of file folders contained in a filing drawer.

10. A filing placeholder device comprising:
a filing placeholder having an elongated planar shaft, a magnetic strip, and a wide head member;
wherein said elongated planar shaft extending between a bottom end and a top end;
wherein said elongated planar shaft having a material selected from the group consisting of a semi-rigid polymeric material and a semi-rigid composite material;
wherein said elongated planar shaft having a taper including a wide said bottom end tapering to a narrow said top end;
wherein said magnetic strip is embedded in a posterior surface of said elongated planar shaft;
wherein said wide head member integrally formed at said top end of said elongated planar shaft;
wherein said wide head member having a receiving placeholder along a top edge of said wide head member;
wherein said receiving placeholder selectively receives a removably attachable overlay identification member; and
further wherein a length of said elongated planar shaft corresponds to a height of file folders contained in a filing drawer.

11. The filing placeholder device of claim 10, wherein each of said overlay identification member having an insert shaped to correspond with said receiving placeholder.

12. The filing placeholder device of claim 11, wherein each of said overlay identification member having a visible pattern selected from the group consisting of a multicolored graphic and a writable dry-erase surface.

13. The filing placeholder device of claim 12, wherein each of said overlay identification member having a material selected from the group consisting of a laminated paper, a flexible plastic, and a polymeric film.

14. The filing placeholder device of claim 10, wherein said magnetic strip extends along a central axis of said posterior surface to provide magnetic adherence to ferromagnetic surfaces.

15. The filing placeholder device of claim 14, wherein said elongated planar shaft having a thickness from 0.0625 inches to 0.2500 inches.

16. The filing placeholder device of claim 14, wherein said magnetic strip is co-planar with an exterior surface of said elongated planar shaft.

17. The filing placeholder device of claim 14, wherein said elongated planar shaft having a width from 1.5 inches to 2 inches.

18. A method of placeholding a file folder, the method comprising the steps of:
providing a filing placeholder having an elongated planar shaft, a magnetic strip, and a wide head member, wherein said elongated planar shaft extending between a bottom end and a top end, wherein said elongated planar shaft having a material selected from the group consisting of a semi-rigid polymeric material and a semi-rigid composite material;
embedding said magnetic strip in a posterior surface of said elongated planar shaft;
integrally forming said wide head member at said top end of said elongated planar shaft, wherein said wide head member having a receiving placeholder along a top edge of said wide head member, wherein said receiving placeholder selectively receives a removably attachable overlay identification member;
corresponding a length of said elongated planar shaft to a height of file folders contained in a filing drawer;
removing a file folder from the filing drawer; and
placing said filing placeholder in the same position where the file folder was removed from the filing drawer.

19. The method of placeholding a file folder of claim 18 further comprising the steps of:
locating said filing placeholder in the filing drawer;
returning the removed file folder in front of said filing placeholder; and
removing said filing placeholder from the filing drawer.

20. The method of placeholding a file folder of claim 19, wherein said magnetic strip extends along a central axis of said posterior surface to provide magnetic adherence to ferromagnetic surfaces and further wherein said magnetic strip is co-planar with an exterior surface of said elongated planar shaft.
